(19) United States
(12) Patent Application Publication
(10) Pub. No.: US 2020/0125126 A1
(43) Pub. Date: Apr. 23, 2020

(54) VOLTAGE REGULATOR CIRCUIT WITH HIGH POWER SUPPLY REJECTION RATIO

(71) Applicant: STMicroelectronics International N.V., Schiphol (NL)

(72) Inventors: Nitin GUPTA, Kurukshetra (IN); Prashutosh GUPTA, Ballia (IN)

(73) Assignee: STMicroelectronics International N.V., Schiphol (NL)

(21) Appl. No.: 16/600,968

(22) Filed: Oct. 14, 2019

Related U.S. Application Data
(60) Provisional application No. 62/747,827, filed on Oct. 19, 2018.

(51) Int. Cl. G05F 1/575

(52) U.S. Cl. CPC G05F 1/575

(57) ABSTRACT

An amplifier circuit generates a control signal as a function of a difference between a reference signal and a feedback signal. The control signal is filtered by a low pass filter circuit to generate a filtered control signal. The control signal is applied to the control terminal of a first ballast transistor which sources current to an output node. The filtered control signal is applied to the control terminal of a second ballast transistor which also sources current to the output node. In response to the sourced currents, an output voltage is generated at the output node. A feedback circuit coupled to the output node generates the feedback signal.

### CROSS REFERENCE TO RELATED APPLICATION

This application claims the priority benefit of U.S. Provisional Application for Patent No. 62/747,827 filed Oct. 19, 2018, the disclosure of which is incorporated by reference.

### TECHNICAL FIELD

The present invention generally relates to a voltage regulator circuit and, in particular, to a low drop out (LDO) voltage regulator circuit.

### BACKGROUND

Reference is made to FIG. 1 which shows a circuit diagram for a conventional low drop out (LDO) voltage regulator 10. An unregulated supply voltage Vsupply is provided to the power supply terminal of an operational amplifier 12. An inverting input of the operational amplifier 12 receives a reference voltage Vref that may, for example, be output from a bandgap reference voltage generator circuit. A noninverting input of the operational amplifier 12 receives a feedback voltage Vfb. The output of the operational amplifier 12 generates a control voltage Vc that is applied to the gate terminal of a power metal oxide semiconductor field effect transistor (MOSFET) 14 device (also referred to by those skilled in the art as a ballast transistor). The ballast transistor 14 is a p-channel device having a source terminal connected to the supply voltage Vsupply and a drain terminal connected to an output node 16 where the regulated output voltage Vout is generated and supplied to a load 20. A resistive voltage divider 22, formed by series connected resistors R1 and R2, divides the regulated output voltage Vout to produce the feedback voltage Vfb at the divider tap node. The operational amplifier 12 functions as an error amplifier to determine a difference between the reference voltage Vref and the feedback voltage Vfb. The determined difference is the control voltage Vc. Due to the negative feedback, the control voltage Vc modulates the conductivity of the power transistor 14 to regulate the output voltage Vout to a level where the feedback voltage Vfb substantially equals the reference voltage Vref.

In order to have a small drop out voltage and a large current to drive the load, the power transistor 14 must be a very large device (i.e., the transistor width-to-length W/L ratio, the transistor's size, must be large). Large MOSFET devices suffer from having a correspondingly high input (i.e., gate) capacitance. As a result, the bandwidth of the voltage regulator 10 is low and the power supply rejection ratio (PSRR) of the voltage regulator 10 is also low. One solution to the foregoing problems is to support a high current capacity in the input stage of the operational amplifier 12, but there is a limit on the current increase beyond which the output non-dominant pole leads to instability. Another solution is to make the output pole of the voltage regulator dominant, but this necessitates use of a large output stage compensation capacitor 30 (either off-chip or on chip but occupying a large area).

Neither of the foregoing solutions is ideal. There is accordingly a need in the art to provide a voltage regulator of the low drop out type which has improved PSRR performance.

### SUMMARY

In an embodiment, a circuit comprises: an amplifier circuit configured to generate a control signal as a function of a difference between a reference signal and a feedback signal; a filter circuit configured to filter the control signal and generate a filtered control signal; a ballast circuit comprising: a first ballast transistor coupled to source current to an output node and having a gate terminal that is directly driven by the control signal; and a second ballast transistor coupled to source current to the output node and having a gate terminal that is directly driven by the filtered control signal; and a feedback circuit coupled to the output node and configured to generate the feedback signal.

In an embodiment, a method comprises: determining a difference between a reference signal and a feedback signal; generating a control signal in response to said difference; filtering the control signal to generate a filtered control signal; modulating a conductivity of a first ballast transistor in response to the control signal to generate a first current; modulating a conductivity of a second ballast transistor in response to the filtered control signal to generate a second current; applying the first and second currents to an output node to generate an output voltage; and generating the feedback signal from the output voltage.

In an embodiment, a method comprises: selecting a size of a ballast transistor for a low drop out (LDO) voltage regulator application, said size comprising a transistor width W and a transistor length L; splitting the ballast transistor into a first ballast transistor and a second ballast transistor by a factor M, wherein the first ballast transistor has a size comprising a transistor width W/M and a length L and wherein the second ballast transistor has a size comprising a transistor width of W(1-1/M) and a length L; and selecting a frequency response of a filter circuit for filtering a control signal to be applied to the control terminal of the first ballast transistor in order to generate a filtered control signal to be applied to the control terminal of the second ballast transistor.

### BRIEF DESCRIPTION OF THE DRAWINGS

For a better understanding of the embodiments, reference will now be made by way of example only to the accompanying figures in which:

FIG. 1 is a circuit diagram for a conventional low drop out (LDO) voltage regulator;

FIG. 2 is a circuit diagram for an embodiment of an LDO voltage regulator with improved power supply rejection ratio (PSRR) performance; and

FIG. 3 is a circuit diagram for another embodiment of an LDO voltage regulator with improved PSRR performance.

### DETAILED DESCRIPTION

Reference is now made to FIG. 2 which shows a circuit diagram for an embodiment of an LDO voltage regulator 100 with improved power supply rejection ratio (PSRR) performance. An unregulated supply voltage Vsupply is provided to the power supply terminal of an operational amplifier 112. An inverting input of the operational amplifier 112 receives a reference voltage Vref that may, for example, be output from a bandgap reference voltage generator circuit. A noninverting input of the operational amplifier 112 receives a feedback voltage Vfb. The output of the operational amplifier 112 generates a control voltage Vc that is directly applied to the gate terminal of a first power metal oxide semiconductor field effect transistor (MOSFET) 114a device (also referred to herein as a first ballast transistor). In an example embodiment, the first ballast transistor 114a is a p-channel device having a source terminal connected to the supply voltage Vsupply and a drain terminal connected to an output node 116 where the regulated output voltage Vout is generated and supplied to a load 120. The LDO voltage regulator 100 further includes a second power MOSFET 114ba device (also referred to herein as a second ballast transistor). In this example embodiment, the second ballast transistor 114b is also a p-channel device having a source terminal connected to the supply voltage Vsupply and a drain terminal connected to the output node 116. The gate of the second ballast transistor 114b is connected to the gate of the first ballast transistor 114a through a low pass filter (LPF) 124 so that the gate receives a low pass filter control voltage Vc(lpf) derived from the control voltage Vc. The LPF 124 can be of any suitable circuit design presenting a low pass transfer function so that higher frequency signal components are filtered out from the control voltage Vc. As examples, the LPF 124 circuit may be: a simple first order resistor-capacitor (RC) type passive filter; a higher order passive filter; or an active filter (wherein such filters are well known to those skilled in the art). A resistive voltage divider 122, formed by series connected resistors R1 and R2, divides the regulated output voltage Vout to produce the feedback voltage Vfb at the divider tap node. The operational amplifier 112 functions as an error amplifier to determine a difference between the reference voltage Vref and the feedback voltage Vfb. The determined difference is the control voltage Vc. Due to the negative feedback, the control voltage Vc modulates the conductivity of the first ballast transistor 114a and the filtered control voltage Vc(lpf) modulates the conductivity of the second ballast transistor 114b to regulate the output voltage Vout to a level where the feedback voltage Vfb substantially equals the reference voltage Vref.

Although the illustrated example embodiment utilizes p-channel MOSFETs for the ballast transistors, it will be understood that in an alternative embodiment n-channel MOSFETs could instead be used for transistors 114a and 114b. Still further, MOSFET type transistors are not the only possible transistor types which could be used. Any suitable transconductance circuit device with a control terminal could be configured for use as a ballast transistor. Indeed, bipolar transistors of either NPN or PNP type present another option for ballast transistor selection.

The circuit configuration of FIG. 2 accordingly presents an LDO voltage regulator having a ballast circuit formed by two parallel connected ballast transistors: a) the first ballast transistor (provided by transistor 114a whose gate is directly driven by the control voltage Vc and whose drain is connected to source current to the output node 116) provides a high bandwidth, low gain response to support fine control over the voltage regulation operation that is responsive to high frequency noise/changes; and b) the second ballast transistor (provided by transistor 114b whose gate is indirectly driven by the control voltage Vc; i.e., driven by a low pass filtered version of the control voltage Vc(lpf) and whose drain is connected to source current to the output node 116) provides a low bandwidth, high gain response to support coarse control over the voltage regulation operation that is responsive to direct current (DC)/low frequency noise/changes. It will accordingly be understood that the first ballast transistor (provided by transistor 114a) will operate in conjunction with the second ballast transistor (provided by transistor 114b) in providing the low bandwidth, high gain response, while the first ballast transistor (provided by transistor 114a) further provides the high bandwidth, low gain response.

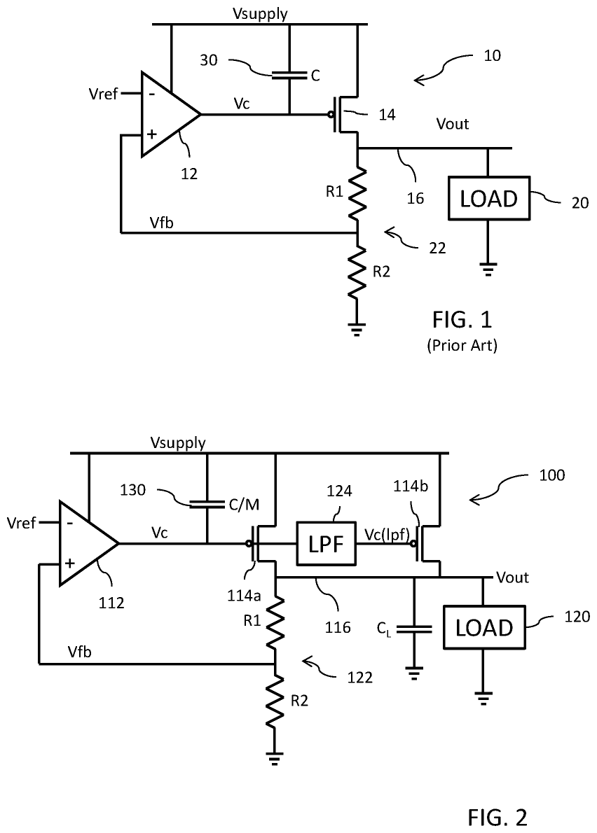

Consider once again the LDO voltage regulator 10 of FIG. 1. Let S represent the size of the ballast transistor 14 required to meet a circuit design load condition. This size S corresponds to a transistor having a transconductance of gm with a transistor width W and a transistor length L. The circuit solution of FIG. 2 with LDO voltage regulator 100 effectively performs a passive splitting of the ballast transistor 14 by a factor of M into the first ballast transistor 114a and second ballast transistor 114b. With respect to the size S=W/L and transconductance gm of the transistor 14, the first ballast transistor 114a has a size S1=(W/M)/L and a transconductance gml=gm/M, and the second ballast transistor 114b has a size S2=(W(1-1/M))/L and a transconductance gm2=gm(1-1/M). With the foregoing relationships, the overall size of the LDO voltage regulator 100 of FIG. 2 is substantially equal to the overall size of the LDO voltage regulator 10 of FIG. 1 (since the overall area occupied by transistors 114a and 114b is the same as the area occupied by transistor 14 and the area occupied by the LPF 124 is relatively speaking very small), but the LDO voltage regulator 100 of FIG. 2 will exhibit improved PSRR performance.

The value M represents the split factor between the fine control path through the first ballast transistor 114a and the coarse control path through the second ballast transistor 114b. The value of M can be selected by the circuit designer depending on any one of a number of design considerations. An important design consideration concerns whether the load 120 is: a) an analog-type circuit load (characterized by a load circuit having a relatively higher output impedance—such as, on the order of a few Kilo ohms to a few Mega ohms), or b) a digital-type circuit load (characterized by a load circuit having a relatively lower output impedance). In the event that the load 120 is of the analog-type, the value for M can be relatively higher. Conversely, in the event that the load 120 is of the digital-type, the value for M can be relatively lower. In fact, for digital-type load circuits, based on the overall overshoot and undershoot on the output voltage Vout, the average switching current can be used to select the value of M.

Thus, a method for circuit design includes first selecting a size of a ballast transistor for a desired low drop out (LDO) voltage regulator application, wherein the size comprises a transistor width W and a transistor length L. The circuit designer then splits the ballast transistor by a factor M into a first ballast transistor and a second ballast transistor. With this split, the first ballast transistor will have a size which comprises a transistor width W/M and a length L and the second ballast transistor will have a size comprising a transistor width of W(1-1/M) and a length L. Once the design for the ballast circuit is made, the LDO voltage regulator circuit for the LDO voltage regulator application can be built using the first and second ballast transistors 114a and 114b coupled in parallel with each other. The circuit design process further includes selecting the frequency response of the low pass filter circuit and building a corresponding LPF 124 so that the first ballast transistor is gate driven by the voltage control signal and the second ballast transistor is gate driven by a low pass filtered version of the voltage control signal.

The input gate capacitance of the ballast transistor is the most important factor in degradation of high frequency PSRR. An operational advance of the LDO voltage regulator 100 of FIG. 2 over the LDO voltage regulator 10 of FIG. 1 is provided by having high frequency variation in the control voltage Vc modulate the conductivity of only the first ballast transistor 114a whose input gate capacitance is much smaller than that of transistor 14 of FIG. 1. The LPF 124 blocks the high frequency variation from reaching the gate of the second ballast transistor 114b, and thus its gate capacitance does not negatively affect PSRR performance.

A further advantage of the LDO voltage regulator 100 of FIG. 2 is that the split ballast transistor configuration enables implementation of an LDO voltage regulator circuit having output pole dominance (for example, with on-chip capacitor usage in the output stage of the operational amplifier for compensation) since the non-dominant input pole is sent to a higher frequency by the factor of the value M. Additionally, in the situation where the LDO voltage regulator circuit is already output pole dominated by having a large bias current in the operational amplifier, the current in the input stage of the operational amplifier can be reduced by the factor of the value M. An assumption is made here of a linear relationship which may not necessarily be true if parasitics become significant at higher currents. In any event, it should be noted that stability of the circuit is nonetheless maintained.

The split ballast transistor configuration further enables implementation of a LDO voltage regulator circuit that is input pole dominated to possess improved PSRR performance because the zero in the PSRR curve is pushed to a higher frequency dependent on the compensation strategy used in the operational amplifier. If the input pole dominance is accomplished by having a compensation capacitor through output to a low impedance/current buffer (such as with the source node of a cascode transistor or a common gate cascode transistor), then the zero is pushed to a higher frequency by a value of M*M. It will be noted that in an absence of use of the split ballast transistor configuration, the same improvement in PSRR performance would require increasing the input stage bias current by a factor of M. In any event, the implementation with the split ballast transistor maintains the output non-dominant pole and unity gain frequency so that there is no adverse impact on stability.

There are significant advantages of the split ballast transistor configuration. As an example, consider M=10. In such a case, there is a power saving by a factor of 10 in the input bias current (for an input pole dominated LDO voltage regulator circuit). Furthermore, where an output pole dominated implementation for the LDO voltage regulator circuit is not possible, the split ballast transistor configuration can enable an output pole dominated design with a capacitor at the output stage that is smaller by a factor of 10. In other words, stability of the LDO voltage regulator circuit can be achieved with an output stage capacitor C_{L} of the regulator circuit that is 10 times smaller than would be needed with the FIG. 1 circuit implementation.

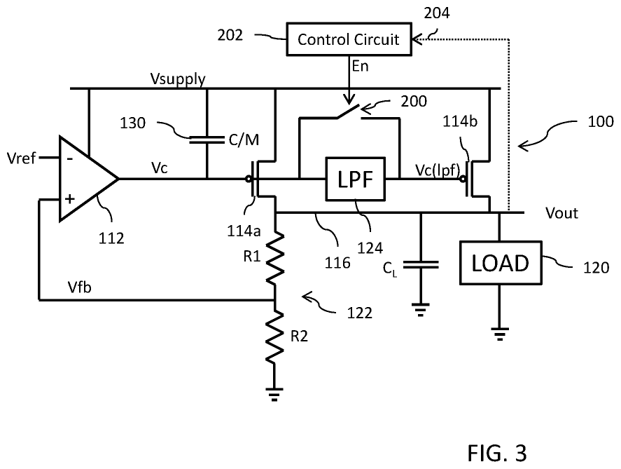

Reference is now made to FIG. 3 which shows a circuit diagram for another embodiment of the LDO voltage regulator 100. Like reference numbers refer to like or similar components of FIG. 2. The regulator circuit of FIG. 3 differs from the regulator circuit of FIG. 2 in the addition of a switching circuit 200 which operates to selectively bypass the LPF 124 and directly electrically connect the gate of the second ballast transistor 114b to the gate of the first ballast transistor 114a. When switching circuit 200 is actuated, the LPF 124 is bypassed, the gates of the first and second ballast transistors 114a and 114b are both driven by the control voltage Vc and the LDO voltage regulator 100 is essentially identical to the LDO voltage regulator 10 of FIG. 1. Conversely, when switching circuit 200 is deactuated, the gate of the first ballast transistor 114a is driven by the control voltage Vc and the gate of the second ballast transistor 114b is driven by the low pass filtered control voltage Vc(lpf).

A control circuit 202 controls enabling of the LPF 124 through controlled actuation of the switching circuit 200 in response to the enable signal En. For example, at start-up of the LDO voltage regulator the control circuit 202 actuates the switching circuit 200 to disable (i.e., bypass) the LPF 124. After regulator load current is active at the output node 116, the control circuit 202 deactuates the switching circuit 200 to enable the LPF 124. The control circuit 202 includes an input 204 coupled to the output node 116 and configured to sense load current.

While the invention has been illustrated and described in detail in the drawings and foregoing description, such illustration and description are considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

What is claimed is:

1. A circuit, comprising:
an amplifier circuit configured to generate a control signal as a function of a difference between a reference signal and a feedback signal;
a filter circuit configured to filter the control signal and generate a filtered control signal;
a ballast circuit comprising:
a first ballast transistor coupled to source current to an output node and having a gate terminal that is directly driven by the control signal; and
a second ballast transistor coupled to source current to the output node and having a gate terminal that is directly driven by the filtered control signal; and
a feedback circuit coupled to the output node and configured to generate the feedback signal.

2. The circuit of claim 1, wherein said first and second ballast transistors are connected in parallel between a supply voltage node and the output node.

3. The circuit of claim 1, wherein the filter circuit is a low pass filter circuit.

4. The circuit of claim 1, wherein the feedback circuit is a resistive voltage divider circuit.

5. The circuit of claim 1, wherein the first and second ballast transistors are p-channel MOSFETs.

6. The circuit of claim 5, wherein:
the first ballast transistor has a source terminal directly connected to a power supply node and a drain terminal directly connected to the output node; and
the second ballast transistor has a source terminal directly connected to the power supply node and a drain terminal directly connected to the output node.

7. The circuit of claim 1, further comprising a switching circuit connected in parallel with the filter circuit and configured, when actuated, to bypass the filter circuit and directly drive the gate terminal of the second ballast transistor with the control signal.

8. The circuit of claim 7, further comprising a control circuit configured to control actuation of the switching circuit.

9. The circuit of claim 8, wherein the control circuit actuates the switching circuit during circuit start-up.

10. The circuit of claim 8, wherein the control circuit is configured to sense load current at the output node and selectively deactuate the switching circuit in response to sensing the load current.

11. A method, comprising:
determining a difference between a reference signal and a feedback signal;
generating a control signal in response to said difference;
filtering the control signal to generate a filtered control signal;
modulating a conductivity of a first ballast transistor in response to the control signal to generate a first current;
modulating a conductivity of a second ballast transistor in response to the filtered control signal to generate a second current;
applying the first and second currents to an output node to generate an output voltage; and
generating the feedback signal from the output voltage.

12. The method of claim 11, wherein filtering comprises low pass filtering.

13. The method of claim 11, wherein generating comprises dividing the output voltage.

14. The method of claim 11, further comprising selectively bypassing the filtering so as to modulate the conductivity of the second ballast transistor in response to the control signal.

15. The method of claim 14, wherein bypassing occurs during circuit start-up.

16. The method of claim 14, further comprising:
sensing load current at the output node; and
selectively deactuating bypassing in response to the senses load current.

17. A method, comprising:
selecting a size of a ballast transistor for a low drop out (LDO) voltage regulator application, said size comprising a transistor width W and a transistor length L;
splitting the ballast transistor into a first ballast transistor and a second ballast transistor by a factor M, wherein the first ballast transistor has a size comprising a transistor width W/M and a length L and wherein the second ballast transistor has a size comprising a transistor width of W(1-1/M) and a length L; and
selecting a frequency response of a filter circuit for filtering a control signal to be applied to the control terminal of the first ballast transistor in order to generate a filtered control signal to be applied to the control terminal of the second ballast transistor.

18. The method of claim 17, further comprising:
selecting an output stage capacitance for the LDO voltage regulator application; and
dividing the compensation capacitance by M to choose an output stage capacitor to be coupled to an output of the voltage regulator.

19. The method of claim 17, further comprising:
selecting a bias current level of an error amplifier for the LDO voltage regulator application; and
dividing the bias current level by M to specify error amplifier bias current for the error amplifier generating said control signal.
